(19) United States
(12) Patent Application Publication
(10) Pub. No.: US 2016/0275657 A1
(43) Pub. Date: Sep. 22, 2016

(54) IMAGING APPARATUS, IMAGE PROCESSING APPARATUS AND METHOD OF PROCESSING IMAGE

(71) Applicant: Panasonic Intellectual Property Management Co., Ltd., Osaka (JP)

(72) Inventors: Kozo EZAWA, Osaka (JP); Takashi KAWAMURA, Kyoto (JP); Khang NGUYEN, Osaka (JP); Shunsuke YASUGI, Osaka (JP)

(21) Appl. No.: 15/068,917

(22) Filed: Mar. 14, 2016

(30) Foreign Application Priority Data
Mar. 19, 2015 (JP) 2015-056729
Feb. 26, 2016 (JP) 2016-034943

(51) Int. Cl. G06T 5/00

(52) U.S. Cl. CPC G06T 5/003; G06T 2207/10016

(57) ABSTRACT

An imaging apparatus including: an imaging unit that images an object and generates imaging data; an image processor that generates image data from the imaging data, and generates an imaging check-purpose image from the image data; and a displaying unit that displays the imaging check-purpose image. The image processor detects a blur amount of the image data, and calculates information relating to a distance to the object using the blur amount. The image processor determines a focus state of the image data, and divides the image data into a first region including a focused region and a second region which is a region other than the first region. The image processor generates the imaging check-purpose image by performing, on the image data, enhancement processing of enhancing a visual difference between the image data of the first region and the image data of the second region using the distance-relating information.

### BACKGROUND

1. Technical Field

The present disclosure relates to an imaging apparatus for capturing an image, an image processing apparatus processing an image, and a method of processing an image.

2. Description of the Related Art

PTL 1 discloses a method including: partitioning an image of a photographic image data into a main subject region and a region not including the main subject; and performing blur enhancement processing on an image of the region not including the main subject out of the image of the photographic image data to enlarge the degree of blur of the image after the image processing in proportion to the magnitude of the detected degree of blur of the image.

PTL 2 discloses a method of generating a blurring image that may be obtained through use of optical zoom, by changing a blur amount of an out-of-focus subject by image processing in accordance with a magnification of digital zoom.

### CITATION LIST

### Patent Literatures

PTL 1: Japanese Patent No. 4924430

PTL 2: Unexamined Japanese Patent Publication No. 2012-160863

### SUMMARY

The present disclosure provides an imaging apparatus, an image processing apparatus, and a method of processing an image, each of which makes it easier to check the focus state of a pointed object in a focus adjustment mode.

An imaging apparatus of the present disclosure includes: an imaging unit that images an object and generates imaging data; an image processor that generates image data from the imaging data, and generates an imaging check-purpose image from the image data; and a displaying unit that displays the imaging check-purpose image. The image processor detects a blur amount of the image data, and calculates information relating to a distance to the object using the blur amount. The image processor determines a focus state of the image data, and divides the image data into a first region including a focused region and a second region which is a region other than the first region. The image processor generates the imaging check-purpose image by performing, on the image data, enhancement processing of enhancing a visual difference between the image data of the first region and the image data of the second region using the distance-relating information without changing one of an angle of view and framing of the image data, in accordance with resolution of the displaying unit.

An image processing apparatus of the present disclosure generates image data from imaging data imaged by an imaging unit, the image processing apparatus generating an imaging check-purpose image from the image data and outputting the imaging check-purpose image to a displaying unit. The image processing apparatus includes a determination unit and an enhancing unit. The determination unit detects a blur amount of the image data and calculating information relating to a distance to an object using the blur amount. The determination unit determines a focus state of the image data and divides the image data into a first region including a focused region and a second region which is a region other than the first region. The enhancing unit generates the imaging check-purpose image by performing, on the image data, enhancement processing of enhancing a visual difference between the first region and the second region using the distance-relating information without changing one of an angle of view and framing of the image data, in accordance with resolution of the displaying unit.

A method of processing an image of the present disclosure includes generating image data from imaging data imaged by an imaging unit, generating an imaging check-purpose image from the image data, and outputting the imaging check-purpose image to a displaying unit, the method further including a distance information calculating step, a region division step, and an enhancement processing step. In the distance information calculating step, a blur amount of the image data is detected and information relating to a distance to an object is calculated using the blur amount. In the region division step, a focus state of the image data is determined, and the image data is divided into a first region including a focused region and a second region which is a region other than the first region. In the enhancement processing step, the imaging check-purpose image is generated by performing, on the image data, enhancement processing of enhancing a visual difference between the first region and the second region using the distance-relating information without changing one of an angle of view and framing of the image data, in accordance with resolution of the displaying unit.

The imaging apparatus of the present disclosure is effective for facilitating determination of the focus state of a pointed object in a focus adjustment mode.

### BRIEF DESCRIPTION OF DRAWINGS

FIG. 1 is a block diagram showing an exemplary structure of an imaging apparatus according to an exemplary embodiment;

FIG. 2 is a block diagram showing the functional structure of the imaging apparatus according to the present exemplary embodiment;

FIG. 3 is a flowchart describing operations in a focus adjustment mode according to the present exemplary embodiment;

FIG. 4 is a flowchart describing operations of an image processor according to the present exemplary embodiment;

FIG. 5 is a schematic diagram for describing the DFD (Depth From Defocus) scheme;

FIG. 6 is a diagram showing an exemplary imaging check-purpose image (without enhancement processing) according to the present exemplary embodiment;

FIG. 7 is a diagram for describing division of image data into regions based on a determination result of the focus state according to the present exemplary embodiment;

FIG. 8 is a diagram showing the relationship between a distance and a blur amount in image data according to the present exemplary embodiment;

FIG. 9 is a diagram for describing an exemplary imaging check-purpose image (with enhancement processing by a blur amount) according to the present exemplary embodiment;

FIG. 10 is a diagram showing the relationship between a distance and right-left parallax in image data according to the present exemplary embodiment;

FIG. 11 is a diagram describing an exemplary imaging check-purpose image (with enhancement processing by three-dimensional display) according to the present exemplary embodiment;

FIG. 12 is a diagram showing the relationship between a distance and brightness difference in image data according to the present exemplary embodiment; and

FIG. 13 is a diagram describing an exemplary imaging check-purpose image (with enhancement processing by brightness) according to the present exemplary embodiment.

### DETAILED DESCRIPTION OF THE PREFERRED EMBODIMENT

The inventors have found that the conventional imaging apparatuses described in the “Description of the Related Art” are associated with the following problems.

For example, with the imaging apparatuses disclosed in PTL 1 and PTL 2, in the case where the resolution of a displaying unit which displays an imaging check-purpose image for checking the focus state of a pointed object is lower than the resolution of an imaging element, the imaging check-purpose image displayed on the displaying unit cannot be accurate reproduction of the focus state of the imaging data. Further, when a focus adjustment is performed while enlarging the region of the focusing target, it becomes difficult to check the condition of the entire object. This hinders the user from accurately grasping the focus state of the pointed object, and the user may feel the manipulation is awkward.

Accordingly, in order to solve such problems, the present disclosure provides an imaging apparatus, an image processing apparatus, and a method of processing an image, each of which facilitates determination of the focus state of a pointed object in accordance with the resolution of a displaying unit without changing the angle of view and framing of an imaging check-purpose image displayed on the displaying unit.

In the following, with reference to the drawings as appropriate, an exemplary embodiment will be described in detail. However, an excessively detailed description may be omitted. For example, a detailed description of a well-known matter or a repetitive description of substantially identical structures may be omitted. This is to avoid unnecessary redundancy in the following description, and to facilitate understanding of the person skilled in the art.

Note that, the inventors provide the accompanying drawings and the following description for the person skilled in the art to fully understand the present disclosure, and it is not intended to limit the subject disclosed in the scope of claims by the drawings and the description.

### Exemplary Embodiment

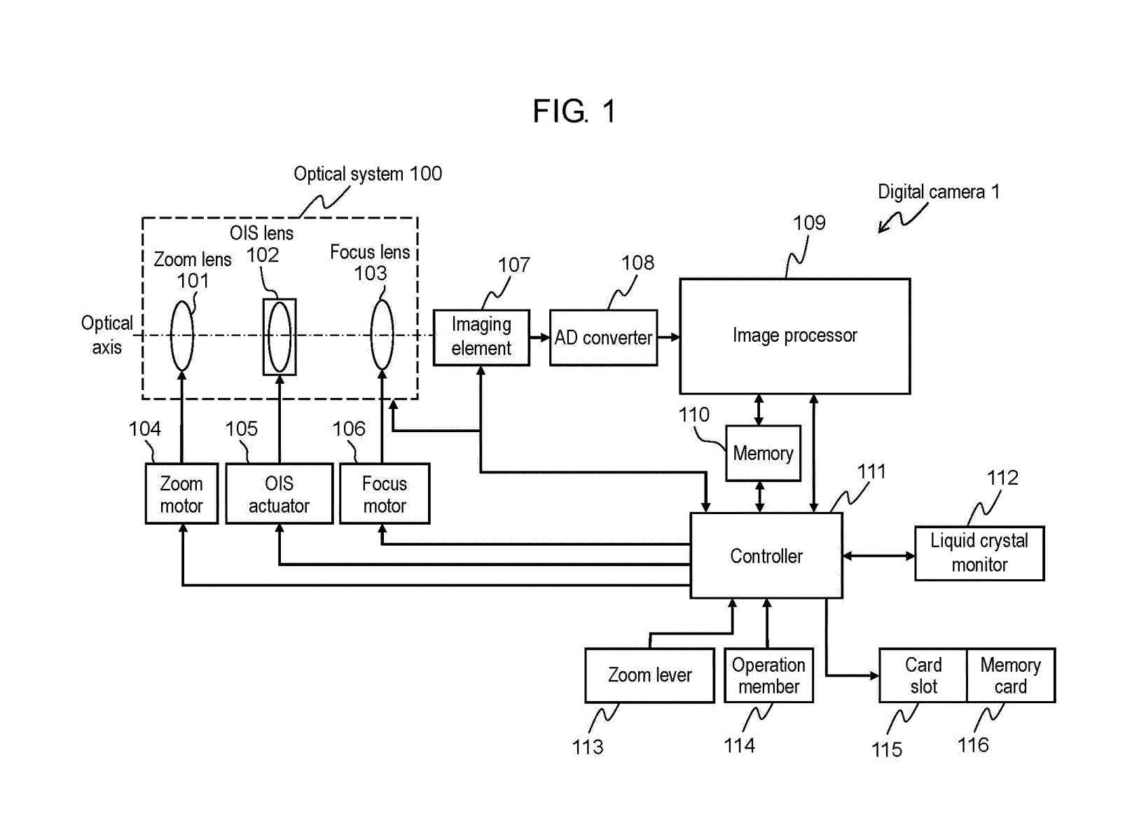

In the following, with reference to FIGS. 1 to 13, a description will be given of a first exemplary embodiment of the present disclosure.

[1. Hardware Structure]

FIG. 1 is a block diagram showing an exemplary structure of an imaging apparatus according to the present exemplary embodiment. FIG. 1 is a block diagram showing the structure of digital camera 1 as an exemplary imaging apparatus according to the present exemplary embodiment. The imaging apparatus may be a video camera, or a mobile terminal such as a mobile phone or a smartphone.

As shown in FIG. 1, digital camera 1 includes optical system 100 structured by a plurality of lens groups, zoom motor 104 for manipulating the lens groups of optical system 100, OIS (Optical Image Stabilizer) actuator 105 for shake correction, and focus motor 106. Further, digital camera 1 includes imaging element 107, AD converter 108, image processor 109, memory 110, and controller 111. Additionally, digital camera 1 includes liquid crystal monitor 112, zoom lever 113, operation member 114, card slot 115, and memory card 116.

Optical system 100 includes zoom lens 101 structured by a plurality of lens groups, OIS lens 102 for shake correction, and focus lens 103 structured by a plurality of lens groups.

Zoom lens 101 is for enlarging or reducing an object image formed on imaging element 107, by shifting along the optical axis of optical system 100. Zoom lens 101 shifts in the optical axis direction of the optical system 100 by actuation of zoom motor 104 in response to control signals from controller 111, to thereby enlarge or reduce an object image. Zoom motor 104 may be implemented by a pulse motor, a DC motor, a linear motor, or a servomotor. Zoom motor 104 may drive zoom lens 101 via a mechanism such as a cam mechanism or a ball screw. Note that, as optical system 100, a fixed-focal-length lens may be employed in place of zoom lens 101.

OIS lens 102 includes therein a correction lens capable of shifting about the optical axis of the optical system 100 within a plane perpendicular to the optical axis. As OIS actuator 105 is controlled by control signals from controller 111, the correction lens is driven. Thus, OIS lens 102 reduces blur in an object image formed in optical system 100. The correction lens is capable of shifting about the optical axis of optical system 100 within a plane perpendicular to the optical axis within OIS lens 102. OIS actuator 105 can be implemented by a planar coil or an ultrasonic motor.

Focus lens 103 is for adjusting the focus of an object image by shifting along the optical axis of optical system 100. Focus lens 103 shifts in the optical axis of optical system 100 by the actuation of focus motor 106 in response to control signals from controller 111, to thereby adjust the focus of an object image. Focus motor 106 may be implemented by a pulse motor, a DC motor, a linear motor, a servomotor or the like. Focus motor 106 may drive focus lens 103 via a mechanism such as a cam mechanism or a ball screw.

Imaging element 107 generates imaging data by imaging an object image formed by optical system 100. Imaging element 107 may be a CCD (Charge Coupled Device) image sensor, or a CMOS (Complementary Metal-Oxide Semiconductor) image sensor. AD converter 108 converts analog imaging data output from imaging element 107 into digital data.

Image processor 109 generates image data by performing various signal processing on the imaging data. Further, image processor 109 generates, from the image data, an imaging check-purpose image to be displayed on liquid crystal monitor 112 without changing the angle of view and framing. Image processor 109 performs various image processing such as gamma correction, white balance correction, and flaw correction on the imaging data. Image processor 109 can be implemented by a DSP (Digital Signal Processor) or a microcomputer, and is an exemplary image processing apparatus.

Memory 110 functions as working memory of image processor 109 and controller 111. Memory 110 temporarily accumulates the image data and the imaging check-purpose image processed by image processor 109, the imaging data input from imaging element 107 before being processed by image processor 109, and the imaging data output from AD converter 108.

Further, memory 110 temporarily accumulates information of the focus state calculated by image processor 109, information relating to blur such as a blur amount, and distance-relating information such as the object distance (the distance to an object, the defocus amount) and the field distance.

Further, memory 110 temporarily accumulates the image capturing condition of optical system 100 and imaging element 107 in capturing an image. The image capturing condition refers to the angle of view information, the zoom value, the focal length, the ISO (International Organization for Standardization) sensitivity, the shutter speed, the exposure value, the F-number, the inter-lens distance, the image capturing time point, the OIS shift amount, the positional information of focus lens 103 in optical system 100 (the focus position information) and the like. Memory 110 can be implemented by, for example, DRAM (Dynamic Random Access Memory), ferroelectric memory or the like.

Controller 111 controls entire digital camera 1. Controller 111 can be implemented by a semiconductor element or the like. Controller 111 can be structured solely by hardware, or may be implemented by a combination of hardware and software. Controller 111 can be implemented by a microcomputer or the like.

Liquid crystal monitor 112 is a display device which displays the imaging check-purpose image generated by image processor 109. Further, liquid crystal monitor 112 can display various setting information. For example, liquid crystal monitor 112 can display the exposure value, the F-number, the shutter speed, the ISO sensitivity and the like being the image capturing condition in capturing images.

Operation member 114 includes a release button. The release button accepts a push manipulation of a user. When the release button is half-pushed, digital camera 1 starts AF (Autofocus) control and AE (Automatic Exposure) control via controller 111. Further, when the release button is full-pushed, digital camera 1 captures an image of an object. Zoom lever 113 accepts an instruction to change the zoom magnification from the user.

Card slot 115 can be mechanically and electrically connected to memory card 116, and read and write information to and from memory card 116. To card slot 115, memory card 116 can be removably attached. Memory card 116 is a recording medium including therein flash memory, ferroelectric memory or the like. Memory card 116 can be removably attached to card slot 115.

[1-2. Functional Structure of Imaging Apparatus]

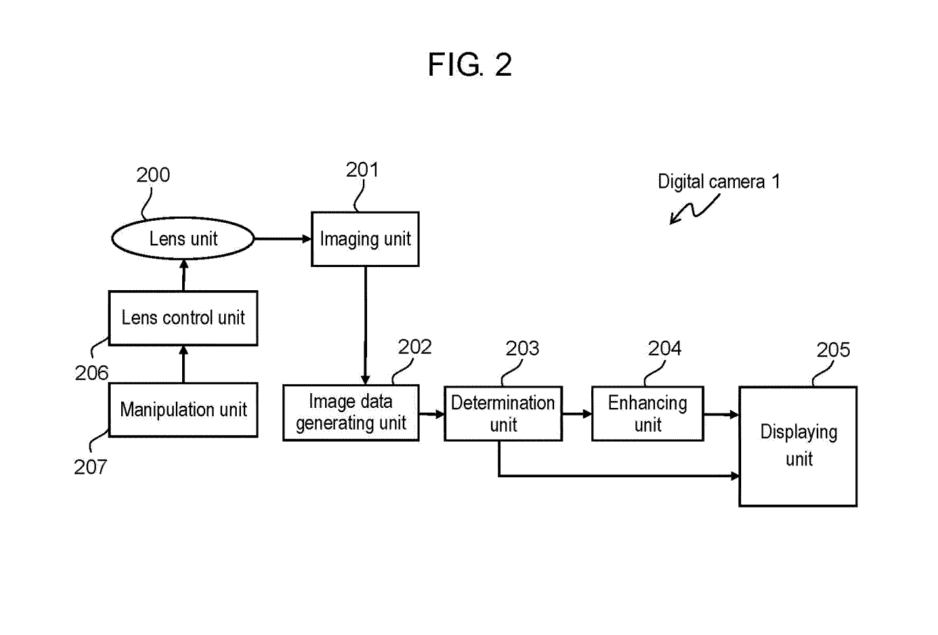

FIG. 2 is a block diagram showing the functional structure of digital camera 1 according to the present exemplary embodiment. FIG. 2 is a block diagram of the sites having the functions relating to operations according to the present exemplary embodiment.

Digital camera 1 includes lens unit 200, imaging unit 201, image data generating unit 202, determination unit 203, enhancing unit 204, displaying unit 205, lens control unit 206, and manipulation unit 207.

Lens unit 200 adjusts the focal length of light from an object, the zoom magnification (the enlarge magnification of an image) and the like. The adjustment is performed under control of lens control unit 206. Lens unit 200 corresponds to optical system 100 shown in FIG. 1.

Imaging unit 201 converts light having transmitted through lens unit 200 into electric signals, and acquires analog imaging data. Imaging unit 201 converts the analog imaging data into digital data. Imaging unit 201 corresponds to imaging element 107 and AD converter 108 shown in FIG. 1.

Image data generating unit 202 performs various image processing on the imaging data acquired by imaging unit 201, to generate image data. Image data generating unit 202 corresponds to the function of generating image data in image processor 109 shown in FIG. 1.

Determination unit 203 compares the resolution of the image data generated by image data generating unit 202 and the resolution of displaying unit 205 against each other, and determines whether or not to perform enhancement processing on the image data. When determination unit 203 determines to perform the enhancement processing, determination unit 203 determines the focus state of a pointed object in the image data. Determination unit 203 controls optical system 100, to acquire by imaging element 107 a plurality of (at least two) images differing from each other in focal position. Then, determination unit 203 performs operational processing by the blur information contained in the acquired images, to calculate the information relating to the distance to the object. Determination unit 203 corresponds to the function of determining the focus state and calculating the distance-relating information in image processor 109 shown in FIG. 1.

Enhancing unit 204 performs prescribed enhancement processing on the image data generated by image data generating unit 202 without changing the angle of view and framing, using the distance-relating information calculated by determination unit 203, and generates an imaging check-purpose image. Enhancing unit 204 divides the image data into an in-focused region and the other region, and performs processing of enhancing the visual difference between the two regions. Enhancing unit 204 corresponds to the function of performing enhancement processing in image processor 109 shown in FIG. 1.

Displaying unit 205 displays the imaging check-purpose image output from enhancing unit 204. Displaying unit 205 corresponds to liquid crystal monitor 112 shown in FIG. 1.

Lens control unit 206 controls lens unit 200 corresponding to optical system 100. Lens control unit 206 corresponds to zoom motor 104, OIS actuator 105 and focus motor 106 shown in FIG. 1.

Manipulation unit 207 performs AF control, AE control, zoom magnification and the like. Manipulation unit 207 corresponds to zoom lever 113 and operation member 114 shown in FIG. 1.

[2. Operation]

[2-1. Focus Adjustment]

When the user shoots a picture of an object, the user performs focus adjustment (focal position adjustment) using the focus adjusting function of digital camera 1.

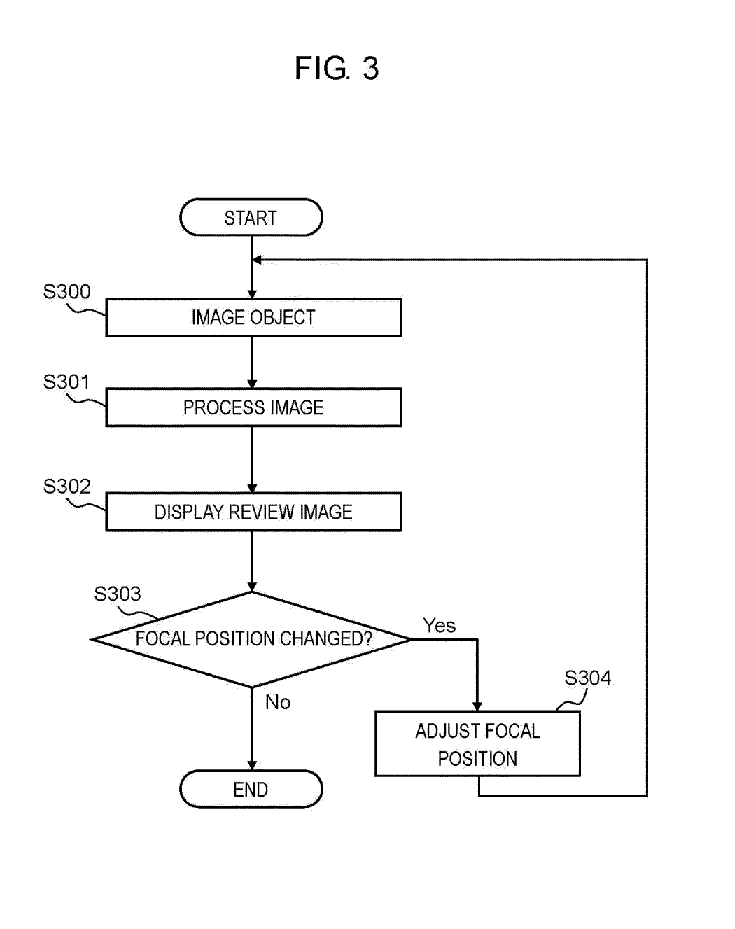

FIG. 3 is a flowchart describing the operations in the focus adjustment mode.

When the user shoots a picture of an object, an image of the object is made incident to the lens groups of optical system 100. The image having transmitted through the lens groups of optical system 100 is made incident to imaging element 107. Imaging element 107 images the incident image, to generate imaging data. AD converter 108 converts the analog imaging data into digital imaging data (Step S300).

Image processor 109 performs various image processing on the imaging data, to generate image data. Then, image processor 109 generates an imaging check-purpose image (review image) from the image data (Step S301). Liquid crystal monitor 112 displays the imaging check-purpose image generated by image processor 109 (Step S302).

The user checks the focus state of the pointed object by looking at the imaging check-purpose image displayed on liquid crystal monitor 112. Here, in the case where the focal position is changed by the user manipulating operation member 114 or where the focal position is changed by the movement of the object (Yes in Step S303), controller 111 drives focus lens 103 by controlling focus motor 106, to adjust the focal position (Step S304).

When the position of focus lens 103 is adjusted, control returns to Step S300 and proceeds to Step S303. When the focal position is changed again (Yes in Step S303), control proceeds to Step S304. Until the adjustment of the focal position is completed, Steps S300 to S304 are repeated. When the focal position becomes unchanged (No in Step S303), the focus adjustment is completed.

[2-2. Operation of Image Processor]

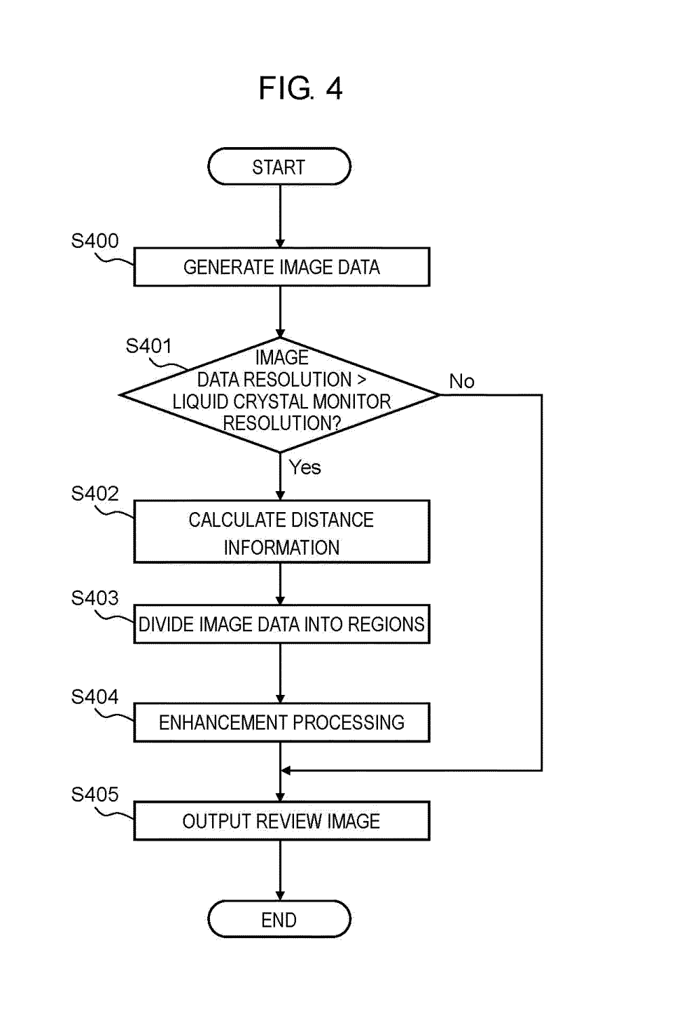

FIG. 4 is a flowchart describing the operations of image processor 109. As described above, image processor 109 has the functions performed by image data generating unit 202, determination unit 203 and enhancing unit 204.

Image data generating unit 202 generates image data by performing prescribed image processing on the imaging data output from imaging unit 201 (Step S400).

Determination unit 203 compares the resolution of the generated image data and the resolution of displaying unit 205 (liquid crystal monitor 112) against each other (Step S401).

When determination unit 203 determines that the resolution of the image data is higher than the resolution of displaying unit 205 (Yes in Step S401), determination unit 203 calculates distance-relating information in the image data (Step S402). Determination unit 203 controls lens unit 200 to acquire, by imaging unit 201, a plurality of (at least two) pieces of imaging data being differing from each other in focal position. Then, determination unit 203 calculates a blur amount contained in the acquired imaging data, and calculates information relating to the distance to the object.

Determination unit 203 determines the focus state of the image data using the distance-relating information calculated in Step S402, and divides the image data into two regions using information relating to the focus state (Step S403). In the present exemplary embodiment, determination unit 203 divides the image data into a first region with a high focusing degree and a second region of the remainder. Here, the focusing degree of the second region is lower than that of the first region.

Next, enhancing unit 204 performs enhancement processing on the image data so as to increase the visual difference between the first region and the second region without changing the angle of view and framing, using the calculated distance-relating information (Step S404). Here, the enhancement processing may be performed on one of or both the first region and the second region. Enhancing unit 204 outputs the image data having undergone the enhancement processing as an imaging check-purpose image (Step S405).

Returning to Step S401, when determination unit 203 determines that the resolution of displaying unit 205 is higher than or equal to the resolution of the image data (No in Step S401), determination unit 203 outputs the image data as an imaging check-purpose image to displaying unit 205, without performing the enhancement processing (Step S405).

[2-3. Calculation of Distance-Relating Information]

As shown in Step S402 in FIG. 4, determination unit 203 performs distance measurement processing by the DFD (Depth from Defocus) scheme based on information relating to blur of a plurality of images (blur amount) acquired by imaging element 107, and calculates distance-relating information.

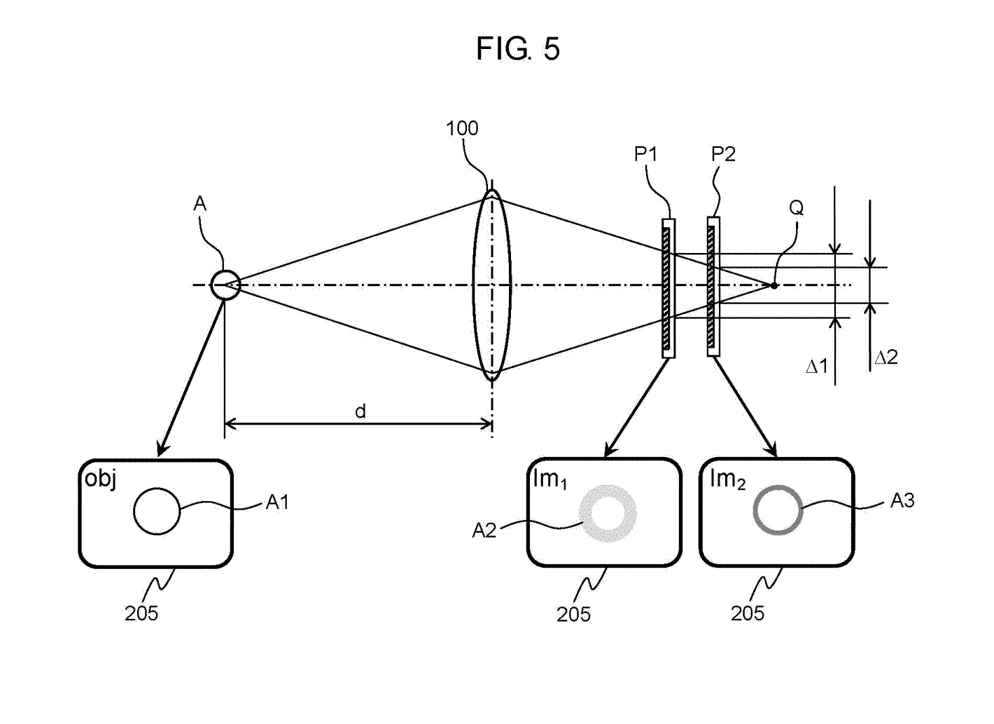

FIG. 5 is a schematic diagram for describing the DFD scheme. As shown in FIG. 5, light from the object is made incident to imaging planes P1, P2 of imaging element 107 via optical system 100. Here, in FIG. 5, point Q represents the focal point.

With an imaging apparatus such as a camera, the image of an object existing at the in-focus position is correctly formed in the state where focus is achieved. In this case, since the focal position of the object plane side and the position of the imaging plane agree with each other, an object image without blur is obtained. In contrast thereto, the image of an object existing at the out-of-focus position is formed as an image in which the shape, contour, boundary and the like of the object are blurred according to focus shift amount. In this case, the focal position of the object plane side and the position of the imaging plane do not agree with each other, and blur corresponding to the difference occurs.

For example, in FIG. 5, when object A is imaged, in the case where focus is achieved, image Obj is displayed as the imaging check-purpose image on displaying unit 205. As shown in FIG. 5, in image Obj, object A is formed as image A1 without blur. At imaging plane P1, the blur amount becomes Δ1, and object A is displayed as image A2 with blur in image Im1 displayed on displaying unit 205. Further, at imaging plane P2, the blur amount becomes Δ2. In this case, in image Im2 displayed on displaying unit 205, object A is displayed as image A3 with blur. As shown in FIG. 5, since imaging plane P1 is farther than imaging plane P2 from focal point Q, blur of object A is greater in image Im1 than in image Im2.

In the DFD scheme, the object distance is measured based on the blur amount of an image whose size or shape changes depending on the distance to the object. The method of measuring the distance by DFD is characterized in that it does not require a plurality of cameras, the distance measurement can be performed with a smaller number of images and the like. Here, the distance-relating information is, for example, the distance from digital camera 1 to the object. In other words, the distance-relating information is the distance in the depth direction as seen from digital camera 1 with respect to the object whose image is captured by imaging element 107. Note that, the reference point of the distance can be arbitrarily set. For example, the reference point may be the position of a prescribed lens among the lenses included in optical system 100.

Here, when the observed image is Im, the object texture information is Obj, the object distance is d, and the point spread function representing blur is PSF(d), observed image Im is expressed by (Mathematical Expression 1).

Im=Obj [symbol] PSF(d) [Mathematical Expression 1]

Since both the values of object texture information Obj and object distance d cannot be obtained from one image Im by the DFD scheme, at least two images differing from each other in focal position are used. For example, in the case shown in FIG. 5, from observed image Im1 at imaging plane P1 and observed image Im2 at imaging plane P2, object texture information Obj and object distance d are calculated. In this case, Im1 and Im2 are respectively expressed by (Mathematical Expression 2) and (Mathematical Expression 3).

Im₁=Obj [symbol] PSF₁(d) [Mathematical Expression 2]

Im₂=Obj [symbol] PSF₂(d) [Mathematical Expression 3]

Then, object distance d is calculated using (Mathematical Expression 2) and (Mathematical Expression 3), and information of the object distance in the entire image data is created. Determination unit 203 associates the calculated values of the blur amount, the field distance, and the object distance with each other and stores in memory 110.

[2-4. Region Division of Image Data]

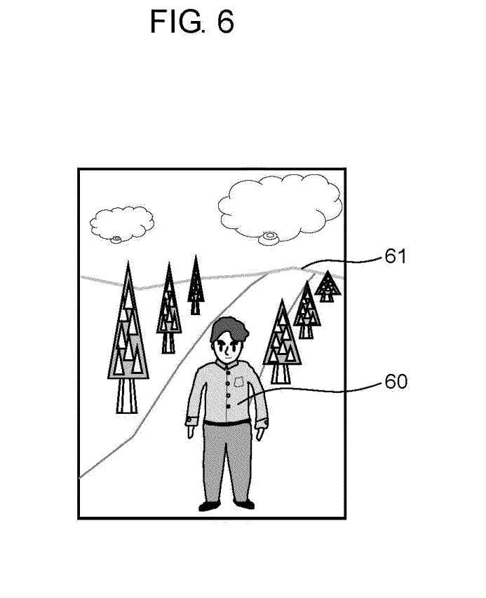

As shown in Step S403 in FIG. 4, determination unit 203 divides the image data into two regions using the focusing degree. FIG. 6 shows exemplary image data generated by image data generating unit 202. In FIG. 6, the image data is structured by pointed object 60 and non-pointed object 61 being the background. In this case, it is assumed that the focal position exists in pointed object 60.

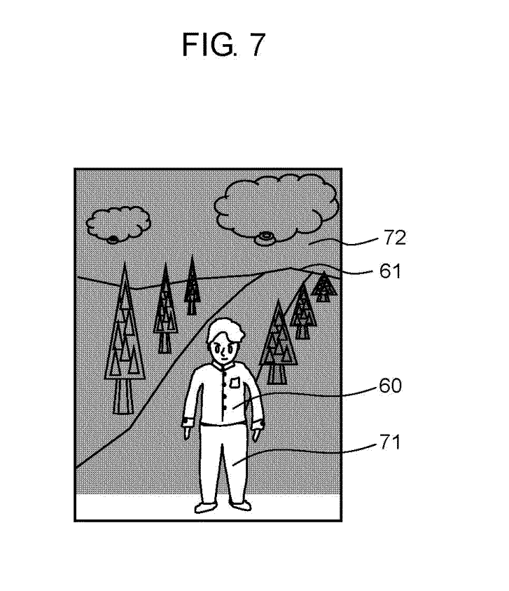

FIG. 7 is a diagram for describing division of image data into regions based on a determination result of the focus state. As shown in FIG. 7, the image data of the imaging check-purpose image shown in FIG. 6 is divided into two regions (first region 71, second region 72). FIG. 7 shows that the region including pointed object 60 is first region 71 with a high focusing degree, and the other region (the shaded region) is second region 72.

[2-5. Enhancement Processing]

As shown in Step S404 in FIG. 4, enhancing unit 204 performs image processing of increasing the visual difference between first region 71 and second region 72 without changing the angle of view and framing, to generate the imaging check-purpose image. In the present exemplary embodiment, as the exemplary enhancement processing, enhancement processing using each of the blur amount, the three-dimensional display, and the brightness will be described. Note that, in the present disclosure, it is assumed that what processing is performed as the enhancement processing is previously set.

[2-5-1. Blur Amount]

Enhancing unit 204 enhances the visual difference by converting the distance-relating information into the blur amount. In the present exemplary embodiment, enhancing unit 204 performs processing of increasing the blur amount at the region (the second region) spaced apart by at least a prescribed distance from the focused region from the current blur amount to a constant blur amount. Note that, as to the setting of the blur amount in the second region, the current blur amount may be increased by a certain amount, or a blur amount being increased in accordance with the current blur amount may be appropriately set.

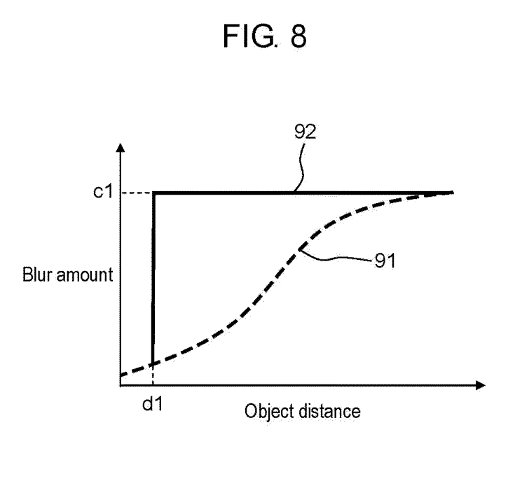

FIG. 8 is a diagram showing the relationship between the distance from the first region and the blur amount in the image data. In FIG. 8, the horizontal axis represents the object distance, and the vertical axis represents the blur amount. Further, graph 91 represents the blur amount before enhancement processing, and graph 92 represents the blur amount after enhancement processing. As shown in FIG. 8, the region up to distance d1 is the first region, being in the state where nearly no blur amount exists. In graph 91, the range exceeding distance d1 is the second region, and it can be seen that the blur amount increases as the distance from the first region increases. In the present exemplary embodiment, enhancing unit 204 performs the processing of changing the blur amount of the second region to maximum value c1 of the blur amount in graph 91. That is, enhancing unit 204 performs enhancement processing of causing the blur amount of the second region to attain the constant blur amount c1 represented by graph 92.

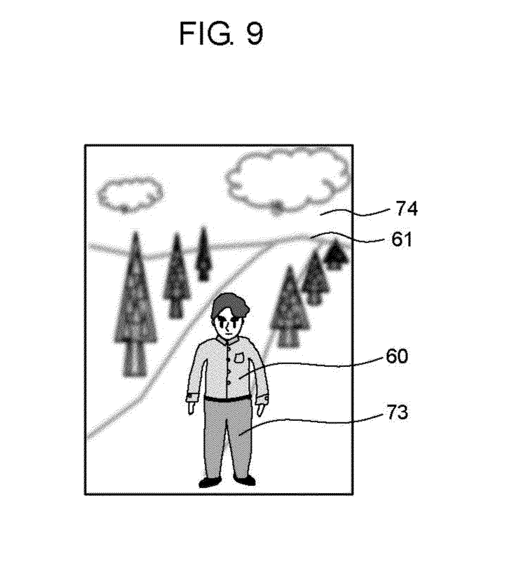

FIG. 9 is a diagram describing an exemplary imaging check-purpose image having undergone the enhancement processing by the blur amount. As shown in FIG. 8, by the enhancement processing by the blur amount according to the present exemplary embodiment, the blur amount of first region 73 is kept as it is, whereas the blur amount of second region 74 is increased to constant blur amount c1. Thus, as shown in FIG. 9, the difference in the blur amount between first region 73 and second region 74 is increased. It can be seen that pointed object 60 of first region 73 has become relatively clear as compared to the imaging check-purpose image before the enhancement processing shown in FIG. 6. Accordingly, the user can easily determine that pointed object 60 is in the focused region.

[2-5-2. Three-Dimensional Display]

Enhancing unit 204 enhances the visual difference by converting the distance-relating information into three-dimensional display. In the present exemplary embodiment, right-left parallax is displayed by displaying a right-eye image and a left-eye image for achieving the three-dimensional display.

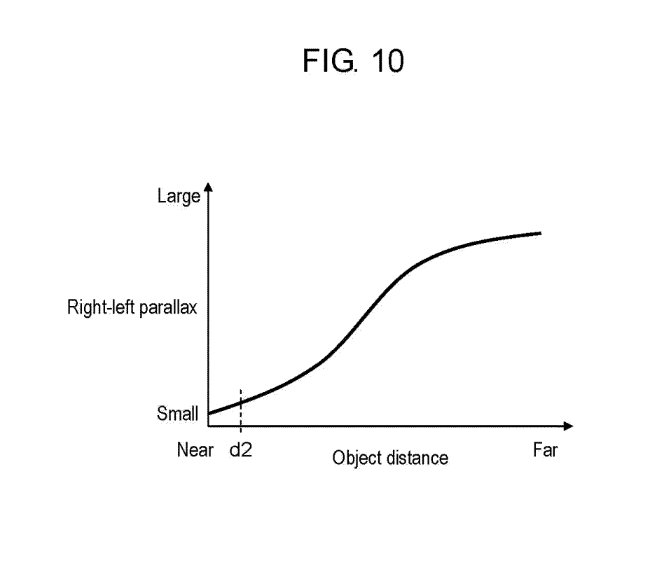

FIG. 10 is a diagram showing the relationship between the distance from the first region and the right-left parallax in the image data. In FIG. 10, the horizontal axis represents the object distance, and the vertical axis represents the right-left parallax. Enhancing unit 204 performs image processing of increasing the right-left parallax as the object distance increases. As shown in FIG. 10, the region up to distance d2 is the first region, being in the state where nearly no right-left parallax exists. The region exceeding distance d2 is the second region. As the distance increases, the right-left parallax increases.

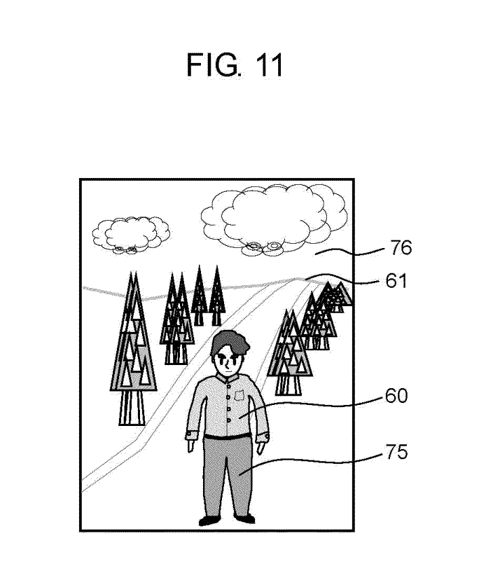

FIG. 11 is a diagram showing an exemplary imaging check-purpose image having undergone the enhancement processing by three-dimensional display. In the present exemplary embodiment, three-dimensional display is a display mode which allows the user to see an image three-dimensionally, by displaying a right-eye image and a left-eye image and letting the user to wear three-dimension eyewear. When the image data is subjected to the image processing by three-dimensional display shown in FIG. 10, as shown in FIG. 11, a right-eye image and a left-eye image are displayed in the imaging check-purpose image. In second region 74, non-pointed object 61 positioned at a farther position from the first region is displayed with its right-eye image and left-eye image being spaced away from each other by a greater distance. That is, as compared to first region 75, the right-left parallax of second region 74 becomes greater, whereby the visual difference between first region 75 and second region 76 becomes clear. Accordingly, the user can easily determine that pointed object 60 is in the focused region. Note that, the method of presenting the three-dimensional display is not limited thereto.

[2-5-3. Brightness]

Enhancing unit 204 enhances the visual difference by converting the distance-relating information into a brightness difference. Enhancing unit 204 performs image processing of increasing the brightness difference between the first region and the second region. In order to increase the brightness difference, enhancing unit 204 may increase the brightness of the first region, may reduce the brightness of the second region, or may combine such increasing and reducing operations. In the present exemplary embodiment, enhancing unit 204 performs processing of increasing the current brightness difference to a constant brightness difference. Note that, as to the setting of the brightness difference, the brightness difference may be increased by a certain amount, or a brightness difference being increased in accordance with the current brightness difference may be appropriately set.

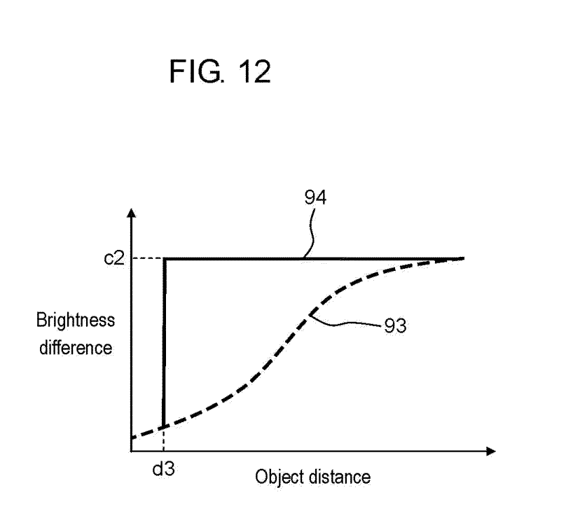

FIG. 12 is a diagram showing the relationship between the distance from the first region in the second region and the brightness difference. In FIG. 12, the horizontal axis represents the object distance, and the vertical axis represents the brightness difference. Further, graph 93 represents the brightness difference before the enhancement processing, whereas graph 94 represents the brightness difference after the enhancement processing. As shown in FIG. 12, the region up to distance d3 is the first region, being in the state where nearly no brightness difference exists. In graph 93, the range exceeding distance d3 is the second region, and it can be seen that the brightness difference increases as the distance from the first region increases. In the present exemplary embodiment, enhancing unit 204 performs processing of changing the brightness of the second region such that the brightness difference attains maximum value c2 in graph 93. That is, enhancing unit 204 performs the enhancement processing of causing the brightness difference of the second region with respect to the first region to attain brightness difference c2 shown in graph 94.

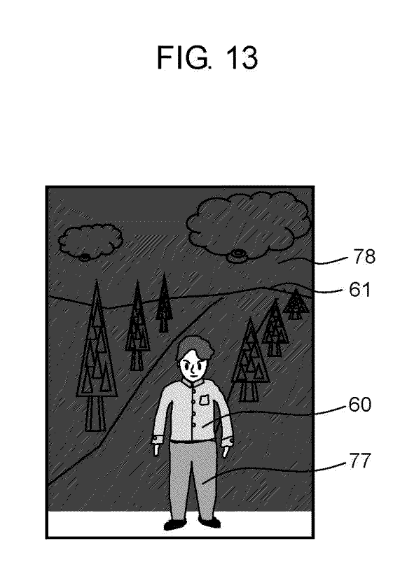

FIG. 13 is a diagram showing an exemplary imaging check-purpose image having undergone the enhancement processing by the brightness difference. As shown in FIG. 13, by the enhancement processing by the brightness difference according to the present exemplary embodiment, the brightness of first region 77 is kept as it is, whereas the brightness of second region 78 is increased such that the brightness difference is increased to constant brightness difference c2. Thus, as shown in FIG. 13, the brightness difference between first region 77 and second region 78 is increased. It can be seen that pointed object 60 of first region 77 has become relatively clear as compared to the imaging check-purpose image before the enhancement processing shown in FIG. 6. Accordingly, the user can easily determine that pointed object 60 is in the focused region.

[3. Effect and Others]

As has been described above, in digital camera 1 according to the present exemplary embodiment, image data generating unit 202 generates image data from imaging data imaged by imaging unit 201. Determination unit 203 detects a blur amount of the image data, and calculates information relating to distance to the object using the blur amount. Determination unit 203 determines the focus state of the image data, and divides the image data into the first region including the focused region and the second region which is a region other than the first region. Enhancing unit 204 performs, on the image data, enhancement processing of enhancing the visual difference between the image data of the first region and the image data of the second region, using the distance-relating information without changing the angle of view or framing of the image data, in accordance with the resolution of displaying unit 205, to thereby generate an imaging check-purpose image. Displaying unit 205 displays the imaging check-purpose image.

Thus, in the imaging check-purpose image displayed on displaying unit 205, the visual difference between the first region which is in-focus and the other second region becomes clear.

Therefore, the user can easily recognize the focused region, which makes it possible to improve the focusing accuracy after the focus adjustment.

Further, since the angle of view and framing of the display data displayed on the displaying unit do not change, an excellent captured image can be obtained without missing checking the composition of the entire imaging data. In particular, deterioration of the focus state can be prevented when focus of a high-resolution image is manually adjusted.

Still further, in the present disclosure, by making full use of the distance information, it becomes possible to accurately display the focused portion without being disturbed by the spatial frequency of the object.

### Other Exemplary Embodiment

In the foregoing, the exemplary embodiment has been described as an example of the technique disclosed in the present application. However, the technique in the present disclosure is not limited thereto, and is applicable to any exemplary embodiment with any change, replacement, addition, omission and the like. Further, a new exemplary embodiment may be made by a combination of the constituent elements described in the above-described exemplary embodiment.

Note that, in the present exemplary embodiment, though the distance to an object is calculated using the DFD scheme, the present exemplary embodiment is not limited thereto. For example, it is also possible to achieve the similar effect by using any known scheme such as the stereo scheme, the TOF (Time Of Flight) scheme and the like.

Further, in the present exemplary embodiment, the image processing using each of the blur amount, the three-dimensional display, and the brightness is performed as the image processing of enhancing the visual difference. However, the present exemplary embodiment is not limited thereto. For example, the color tone may be changed between the first region and the second region.

Still further, in the present exemplary embodiment, previously determined processing is performed as the enhancement processing. However, the enhancement processing may be selected from a plurality of types of enhancement processing, or a plurality of types of enhancement processing may be used in combination. For example, the processing may be selected from a plurality of types of enhancement processing or combined in accordance with the distance-relating information.

Still further, in the present exemplary embodiment, shifting of the focus position is realized by manipulating the position of the focus lens. However, the present exemplary embodiment is not limited thereto. For example, shifting of the focus position may be realized by other method, such as shifting of the imaging element. Accordingly, the information relating to the focus lens position may be the information simply relating to the focus position.

Still further, in the present exemplary embodiment, the distance-relating information is used in determining the focus state. However, the present exemplary embodiment is not limited thereto. For example, the focus state may be determined using the contrast value of the image data, and the image data may be divided into two regions. In this case, the division is made such that the region where the contrast value is higher than a prescribed value is the first region, and the other region is the second region.

The present technique is applicable to an imaging apparatus with which the user adjusts the focal position of an object while seeing a displaying unit. Specifically, the present technique is applicable to a video camera, a single-lens camera, a mobile phone, a smartphone and the like.

What is claimed is:

1. An imaging apparatus comprising:
an imaging unit that images an object and generates imaging data;
an image processor that generates image data from the imaging data, and generates an imaging check-purpose image from the image data; and
a displaying unit that displays the imaging check-purpose image, wherein
the image processor detects a blur amount of the image data, and calculates information relating to a distance to the object using the blur amount,
the image processor determines a focus state of the image data, and divides the image data into a first region including a focused region and a second region which is a region other than the first region, and
the image processor generates the imaging check-purpose image by performing, on the image data, enhancement processing of enhancing a visual difference between the image data of the first region and the image data of the second region using the distance-relating information without changing one of an angle of view and framing of the image data, in accordance with resolution of the displaying unit.

2. The imaging apparatus according to claim 1, wherein the image processor performs the enhancement processing when resolution of the image data is higher than the resolution of the displaying unit.

3. The imaging apparatus according to claim 1, wherein the image processor determines the focus state using the distance-relating information.

4. The imaging apparatus according to claim 1, wherein the image processor determines the focus state using a contrast value of the image data.

5. The imaging apparatus according to claim 1, wherein the enhancement processing is processing of increasing a difference in a blur amount between the image data of the first region and the image data of the second region.

6. The imaging apparatus according to claim 1, wherein the enhancement processing is processing of displaying the image data three-dimensionally.

7. The imaging apparatus according to claim 1, wherein the enhancement processing is processing of increasing a brightness difference between the image data of the first region and the image data of the second region.

8. An image processing apparatus generating image data from imaging data imaged by an imaging unit, the image processing apparatus generating an imaging check-purpose image from the image data and outputting the imaging check-purpose image to a displaying unit, the image processing apparatus comprising:
a determination unit that detects a blur amount of the image data and calculating information relating to a distance to an object using the blur amount, the determination unit determining a focus state of the image data and dividing the image data into a first region including a focused region and a second region which is a region other than the first region; and
an enhancing unit that generates the imaging check-purpose image by performing, on the image data, enhancement processing of enhancing a visual difference between the first region and the second region using the distance-relating information without changing one of an angle of view and framing of the image data, in accordance with resolution of the displaying unit.

9. The image processing apparatus according to claim 8, wherein the enhancing unit performs the enhancement processing when resolution of the image data is higher than the resolution of the displaying unit.

10. A method of processing an image, comprising generating image data from imaging data imaged by an imaging unit, generating an imaging check-purpose image from the image data, and outputting the imaging check-purpose image to a displaying unit, the method comprising:
a distance information calculating step of detecting a blur amount of the image data, and calculating information relating to a distance to an object using the blur amount;
a region division step of determining a focus state of the image data and dividing the image data into a first region including a focused region and a second region which is a region other than the first region; and
an enhancement processing step of generating the imaging check-purpose image by performing, on the image data, enhancement processing of enhancing a visual difference between the first region and the second region using the distance-relating information without changing one of an angle of view and framing of the image data, in accordance with resolution of the displaying unit.

11. The method of processing an image according to claim 10, wherein the enhancement processing is performed when resolution of the image data is higher than the resolution of the displaying unit.
